(19) United States
(12) Patent Application Publication
(10) Pub. No.: US 2002/0177972 A1
(43) Pub. Date: Nov. 28, 2002

(54) Tension control system for rod and bar mills

(76) Inventors: Paul Riches, Paxton, MA (US); Francois Renzine, Murrysville, PA (US); T. Michael Shore, Princeton, MA (US)

Correspondence Address: Att: Maurice E. Gauthier, Samuels, Gauthier & Stevens, LLP, Suite 3300, 225 Franklin Street, Boston, MA, 02110, US

(21) Appl. No.: 10/116,410

(22) Filed: Apr. 4, 2002

Related U.S. Application Data
(60) Provisional application No. 60/283,460, filed on Apr. 12, 2001.

(51) Int. Cl. G01P 5/00; G01P 7/00; G01P 9/00; G01P 11/00; G06F 15/00

(52) U.S. Cl. 702/142

(57) ABSTRACT

A system is disclosed for controlling the tension in rod or bar products being rolled continuously in first and second roll stands independently driven by drive motors. A first surface velocity gauge is positioned at the delivery side of the first roll stand and a second surface velocity gauge is positioned at the entry side of the second roll stand. The first and second gauges are operative, respectively, to continuously measure and generate control signals representative of the exit surface velocity of the product exiting the first roll stand and the entry surface velocity of the product entering the second roll stand. Separately operable controllers are provided for varying the operating speeds of the roll stand drive motors. A data processor operates in response to the control signals generated by the velocity said gauges to determine in real time the differential between the product exit and entry surface velocities, and to generate command signals to the speed controller unit of at least one drive motor to vary the operating speed of that drive motor in order to maintain the differential between the product exit and entry surface velocities within a desired range.

### CROSS REFERENCE TO RELATED APPLICATION

This application claims priority from provisional patent application Ser. No. 60/283,460 filed Apr. 12, 2001.

### BACKGROUND DISCUSSION

1. Field of the Invention

This invention relates to control systems for controlling product tension between successive rolling units or roll stands in rod and bar mills.

2. Description of the Prior Art

An example of conventional rod mill installation is diagrammatically depicted in FIG. 1, where a multi-stand finishing block 10 is followed along the mill pass line “P” by a multi-stand post finishing block 12. The finishing block 10 is driven via a gear unit 14 by a drive motor 16, and the post finishing block 12 is similarly driven via a gear unit 18 by a drive motor 20.

In order to insure smooth passage of the product from block 10 to block 12, the velocity V₂ of the product entering block 12 should be greater than the velocity V₁ of the product exiting from block 10. This velocity differential insures that the product is under tension, thus avoiding cobbling between the successive blocks. While some level of tension is acceptable and indeed desirable, it should be kept at a minimum and relatively constant so as to avoid adversely affecting the gauge of the product being rolled.

In practice, however, maintaining the product under constant minimum tension has proven to be an elusive goal. Accurate real time measurement of bar and rod velocities has not been possible with previously available technology, and reliable velocity calculations have been frustrated by the many constantly shifting variables that must necessarily be taken into consideration.

For example, the exiting velocity V₁ is a function of several factors, including the operating speed (RPM) of motor 16, the gear ratios within the block 10 and its gear unit 14, and the effective roll diameter and forward slip in the last roll pass 10a of the block. Also, motor RPM varies as the block undergoes loading and unloading. Although this dynamic change can be electrically minimized, it cannot be totally eliminated.

Effective roll diameter and forward slip are dependent on many variables, such as but not necessarily all of the following:

Amount of reduction

Temperature of the product

Shape of the roll pass and size of the product

Product speed

Material quality

Surface conditions of the product and rolls

The entering velocity V₂ is a function of the same factors and variables, except that forward slip is replaced by backward slip in the first roll pass 12a of block 12. Backward slip may additionally be affected by water cooling between the blocks, which lowers the temperature of the product and thus increases reduction forces.

Because of these many constantly shifting variables, those skilled in the art have found it necessary to increase the differential between V₁ and V₂. This in turn has resulted in an undesirable increase in product tension.

### SUMMARY OF THE INVENTION

The improved control system of the present invention directly measures exiting and entering product velocities of bar and rod products passing between successive rolling units or roll stands, and employs such measurements to reliably maintain product tension at an optimum minimum level.

In accordance with one aspect of the present invention, a first surface velocity gauge is positioned at the delivery side of a first or upstream roll stand, which may or may not be the final stand of a multi-stand rolling block, and a second surface velocity gauge is positioned at the entry side of a second or downstream roll stand, which may or may not be the lead stand of a multi-stand block. The first and second gauges operate, respectively, to continuously measure and generate control signals representative of the exit surface velocity of a rod or bar product as it exits the first roll stand and the entry surface velocity of the same product as it enters the second roll stand. A data processor operates in response to the gauge control signals to determine the real time velocity differential between the exit and entry surface velocities of the product, and to generate command signals to modify the operating speeds of at least one of the first or second roll stands in order to maintain the velocity differential and resulting interstand product tension within a desired narrow range.

These and other features and advantages of the present invention will now be described in greater detail with reference to the accompanying drawings, wherein:

### BRIEF DESCRIPTION OF THE DRAWINGS

FIG. 1 is a diagrammatic illustration of a conventional rod mill installation;

FIG. 2 is a diagrammatic illustration of a control system in accordance with the present invention; and

FIG. 3 is an enlarged view of a portion of the control system shown in FIG. 1.

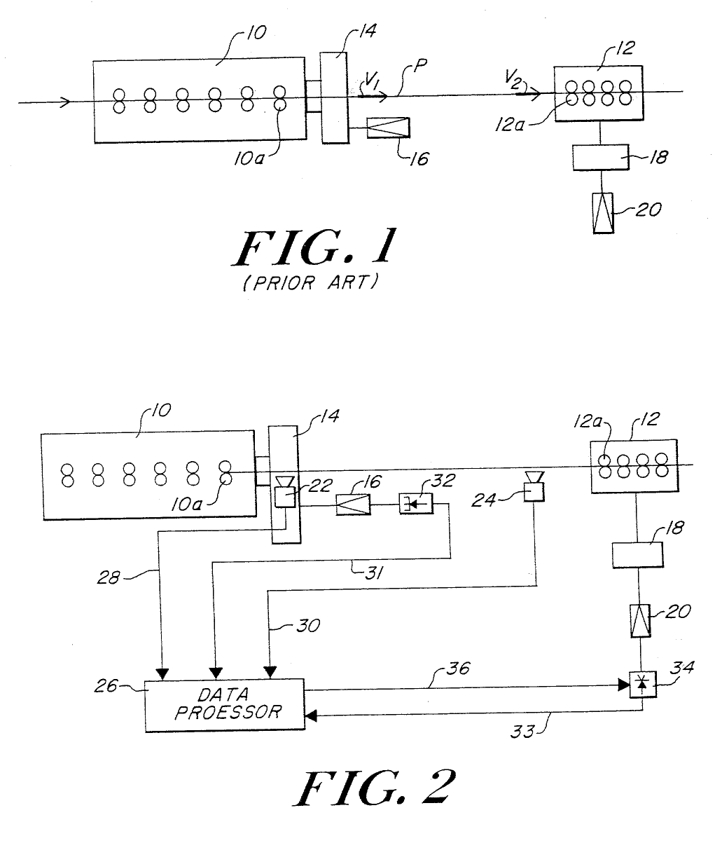

### DETAILED DESCRIPTION OF PREFERRED EMBODIMENT

With reference to FIG. 2, it will be seen that a control system in accordance with the present invention includes first and second laser Doppler surface velocity gauges 22, 24 positioned, respectively, immediately following the last roll stand 10a of finishing block 10 and immediately preceding the first roll stand 12a of post finishing block 12. The gauges 22, 24 are preferably the LM-500-LSV-S2 model obtainable from American Sensors Corp. of Pittsburgh, Pa. U.S.A.

Gauge 22 continuously measures surface the velocity V₁ of product exiting the last roll stand 10a of block 10, and gauge 24 continuously measures the surface velocity V₂ of product entering the first roll stand 12a of post finishing block 12. A data processor 26 receives control signals generated by the gauges representative of product surface velocities V₁ and V₂ via lines 28, 30 and also receives signals via lines 31 and 33 representative of motor speeds from speed controllers 32, 34 associated with motors 16, 20.

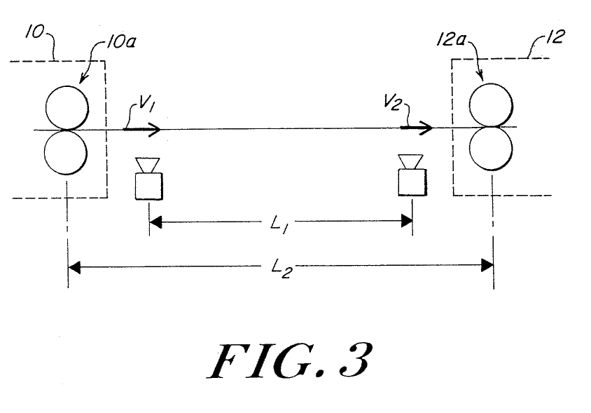

With reference to FIG. 3, it will be seen that the gauges 22, 24 are spaced one from the other by a distance L₁, and that the distance between the last roll stand 10a of block 10 and the first roll stand 12a of post finishing block 12 is L₂.

Because the product is in a state of tension between stands 10a and 12a, some incremental stretching will occur. The data processor 26 operates in real time to determine velocity differential V_{D} between stands 10a and 12a based on the algorithm:

$${V}_{D} = \frac{{V}_{2} - {V}_{1}}{{V}_{2}} \times \frac{{L}_{2}}{{L}_{1}}$$

Based on this real time determination, the data processor generates command signals via line 36 to the speed controller 34 of motor 20 to make any required adjustments to the operating speed of block 12 and its first stand 12a in order to maintain the velocity differential within a desired narrow range. Since product tension between stands 10a and 12a is directly proportional to the velocity differential V_{D}, maintaining V_{D} within a narrow range results in the same degree of control being exercised over product tension. This beneficial result is achieved without having to take into accordance the numerous variable factors described previously.

In light of the foregoing, it will now be apparent to those skilled in the art that various modifications can be made to the embodiment herein disclosed without departing from basic concepts of the present invention. For example, the data processor 26 may be employed in a slightly different manner to alternatively control the speed of motor 16, or to control the speed of both motors 16 and 18. The invention may be applied to control product tension between two successive independently controllable roll stands that are components of multi-stand blocks, as shown, or that are independently arranged along the rolling line.

We claim:

1. A system for controlling the tension in rod or bar products being rolled continuously in first and second roll stands, said roll stands being independently driven by drive motors, said system comprising:
a first surface velocity gauge positioned at the delivery side of said first roll stand and a second surface velocity gauge positioned at the entry side of said second roll stand, said first and second gauges being operative, respectively, to continuously measure and generate control signals representative of the exit surface velocity of the product exiting said first roll stand and the entry surface velocity of the product entering said second roll stand;
separately operable controllers for varying the operating speeds of said drive motors in response to command signals; and
a data processor responsive to the control signals generated by said gauges for determining in real time the velocity differential between said exit and entry surface velocities, and for generating command signals to the speed controller unit of at least one drive motor to vary the operating speed of said drive motor in order to maintain said velocity differential within a desired range.

2. The system of claim 1 wherein said surface velocity gauges comprise laser Doppler gauges.

3. The system of claim 1 wherein said data processor determines said velocity differential based on the algorithm
$${V}_{D} = \frac{{V}_{2} - {V}_{1}}{{V}_{2}} \times \frac{{L}_{2}}{{L}_{1}}$$
where:
V_{D}=velocity differential
V₁=exit surface velocity
V₂=entry surface velocity
L₁=distance between the first and second surface velocity gauges
L₂=distance between the first and second roll stands.

4. A method of controlling the tension in rod or bar produce being rolled continuously in first and second independently driven roll stands, said roll stands having separately controllable operating speeds, said method comprising:
continuously measuring the exit surface velocity of the product exiting said first roll stand and the entry surface velocity of the product entering said second roll stand;
determining in real time the velocity differential between said exit and entry surface velocities; and
varying the operating speed of at least one of said roll stands in order to maintain said velocity differential within a desired range.

5. The method of claim 4 wherein said velocity differential is determined in accordance with the following algorithm:
$${V}_{D} = \frac{{V}_{2} - {V}_{1}}{{V}_{2}} \times \frac{{L}_{2}}{{L}_{1}}$$
where:
V_{D}=velocity differential
V₁=exit surface velocity
V₂=entry surface velocity
L₁=distance between locations at which exit and entry surface velocities are measured
L₂=distance between the first and second roll stands.
